(19) United States
(12) Patent Application Publication
(10) Pub. No.: US 2023/0059370 A1
(43) Pub. Date: Feb. 23, 2023

(54) GAZE AND AWARENESS PREDICTION USING A NEURAL NETWORK MODEL

(71) Applicant: Waymo LLC, Mountain View, CA (US)

(72) Inventors: Junhua Mao, Palo Alto, CA (US); Xinwei Shi, Cupertino, CA (US); Anne Hobbs Dorsey, Palo Alto, CA (US); Rui Yan, Mountain View, CA (US); Chi Yeung Jonathan Ng, San Francisco, CA (US)

(21) Appl. No.: 17/886,747

(22) Filed: Aug. 12, 2022

Related U.S. Application Data
(60) Provisional application No. 63/234,338, filed on Aug. 18, 2021.

(51) Int. Cl. G06V 20/58; G06V 10/82; G06T 7/70; G06V 10/80; B60W 60/00

(52) U.S. Cl. CPC G06V 20/58; B60W 60/001; G06T 7/70; G06V 10/80; G06V 10/82; B60W 2420/42; B60W 2554/4029; B60W 2554/4047; G06T 2207/10028; G06T 2207/20081; G06T 2207/20084; G06T 2207/30201; G06T 2207/30252

(57) ABSTRACT

Methods, systems, and apparatus, including computer programs encoded on a computer storage medium, for predicting gaze and awareness using a neural network model. One of the methods includes obtaining sensor data (i) that is captured by one or more sensors of an autonomous vehicle and (ii) that characterizes an agent that is in a vicinity of the autonomous vehicle in an environment at a current time point. The sensor data is processed using a gaze prediction neural network to generate a gaze prediction that predicts a gaze of the agent at the current time point. The gaze prediction neural network includes an embedding subnetwork that is configured to process the sensor data to generate an embedding characterizing the agent, and a gaze subnetwork that is configured to process the embedding to generate the gaze prediction.

### CROSS-REFERENCE TO RELATED APPLICATION

This application claims priority to U.S. Provisional Application No. 63/234,338, filed on Aug. 18, 2021. This disclosure of the prior application is considered part of and is incorporated by reference in the disclosure of this application.

### BACKGROUND

This specification relates to autonomous vehicles.

Autonomous vehicles include self-driving cars, boats, and aircrafts. Autonomous vehicles use a variety of on-board sensors and computer systems to detect nearby objects and use such detections to make control and navigation decisions.

Some autonomous vehicles have on-board computer systems that implement neural networks, other types of machine learning models, or both for various prediction tasks, e.g., object classification within images. For example, a neural network can be used to determine that an image captured by an on-board camera is likely to be an image of a nearby car.

Autonomous and semi-autonomous vehicle systems can use full-vehicle predictions for making driving decisions. A full-vehicle prediction is a prediction about a region of space that is occupied by a vehicle. The predicted region of space can include space that is unobservable to a set of on-board sensors used to make the prediction.

Autonomous vehicle systems can make full-vehicle predictions using human-programmed logic. The human-programmed logic specifies precisely how the outputs of on-board sensors should be combined, transformed, and weighted, in order to compute a full-vehicle prediction.

### BRIEF DESCRIPTION OF THE DRAWINGS

FIG. 1 is a diagram of an example system.

FIG. 2 is an example architecture of a gaze prediction neural network.

FIG. 3 is a flow chart of an example process for gaze and awareness prediction.

FIG. 4 is a flow chart of an example process for training a gaze prediction neural network with auxiliary tasks.

Like reference numbers and designations in the various drawings indicate like elements.

### DETAILED DESCRIPTION

In a real driving environment, e.g., an urban environment in a big city, it is important for an autonomous vehicle to accurately “interpret” non-verbal communications from agents, e.g., motorists, pedestrians or cyclists, to better interact with them. For example, such non-verbal communications are important when there is no clear rule to decide who has the right of way, such as a pedestrian crossing at a street or intersection where the right-of-way for agents, e.g., motorists, cyclists, and pedestrians, is not controlled by a traffic signal.

An awareness signal is a signal that can indicate whether the agent is aware of the presence of one or more entities in the environment. For example, the awareness signal can indicate whether the agent is aware of a vehicle in the environment. The awareness signals of the agents to the autonomous vehicle can be important for the communications between the agents and the autonomous vehicle. The on-board system of the autonomous vehicle can use the awareness signals of the agents to plan a future trajectory of the vehicle, predict intent for the agents, and predict whether it is safe to drive close to the agents.

Gaze is one of the most common ways for the agents to communicate their awareness. Gaze is a steady and intentional look at an entity in the environment that can indicate an agent’s awareness and perception of the entity. For example, at an unsignalized roadway, a pedestrian can look around the surrounding vehicles while crossing the unsignalized roadway. Sometimes, in addition to gaze, the agents might make a gesture that indicates awareness, e.g., a handwave, a subtle movement in the direction of the road, a smile, or a head wag.

Some conventional gaze predictors may rely on a face detector or a head detector that takes a two-dimensional camera image as input and generates a detected face or a detected head of an agent characterized in the camera image and then generates a gaze prediction from the output of the face or head detector. A face detector or a head detector may have low recall rate when the agent is not facing the camera, when the agent is wearing a hat, or when the agent is looking downward, e.g., looking at a phone. Even if the face or the head is correctly detected by the detector, estimating the gaze of the agent from a two-dimensional camera image can still be very challenging and the gaze estimation results may not be accurate.

This specification describes systems and techniques for generating a gaze prediction that predicts a gaze direction of an agent that is in the vicinity of an autonomous vehicle in an environment. The gaze prediction can be defined as the predicted direction of a person’s eyes or face. In some implementations, the systems and techniques can use the gaze prediction to generate an awareness signal that indicates whether the agent is aware of the presence of one or more entities in the environment. The agent is aware of the presence of an entity if the agent has knowledge or is informed that an entity exists in the environment. The agent is unaware of the presence of an entity if the agent does not know that an entity exists in the environment. The systems and techniques according to example aspects of the present specification can use the gaze prediction and/or the awareness signal generated from the gaze prediction to determine a future trajectory of the autonomous vehicle.

Particular embodiments of the subject matter described in this specification can be implemented so as to realize one or more of the following advantages.

Instead of relying on a head detector or a face detector, the systems and techniques can accurately predict a gaze direction of an agent directly from raw sensor data using a gaze prediction neural network. In some cases, the systems and techniques can generate accurate gaze predictions based on input data from different sensor types, e.g., camera images and point clouds. The systems and techniques can efficiently represent the gaze prediction in 2.5D, including: gaze direction in the horizontal plane in degrees and gaze direction in the vertical axis in discrete classes.

The systems and techniques can generate, based on the gaze prediction, an awareness signal that indicates whether the agent is aware of the presence of one or more entities in the environment. In some implementations, the systems and techniques can determine whether the agent has been aware of the one or more entities in the past based on a historical awareness signal included in the awareness signal For example, although the agent is not currently looking at an vehicle, the system can still determine that the agent is aware of the vehicle because the agent may remember the presence of the vehicle if the agent has looked at the vehicle before.

The systems and techniques can use the gaze prediction and/or the awareness signal generated from the gaze prediction to determine a future trajectory of the autonomous vehicle or to predict the future behavior of the agent in the environment. The systems and techniques can generate a reaction type prediction of the agent to the one or more entities in the environment, e.g., yielding, passing, or ignoring the autonomous vehicle, based on the awareness signal. The systems and techniques can adjust a reaction time using one or more reaction time models based on the awareness signal, e.g., how fast the pedestrian would react to the vehicle’s trajectory. The systems and techniques can adjust, based on the awareness signal, the size of the buffer between the vehicle and the agent when the vehicle passes by the agent, e.g., increasing the buffer size if the agent is not likely aware of the vehicle, for improved safety.

A training system can train the gaze prediction neural network on the gaze prediction task jointly with training the gaze prediction neural network on one or more auxiliary tasks such that the gaze prediction neural network can learn the features of the gaze individually, e.g., reducing the chance that the gaze prediction neural network heavily relies on the heading directions of the agent to generate the gaze predictions. To help the neural network model to learn the difference between gaze (e.g., the direction of a face) and heading (e.g., the direction of a torso) and to generate more accurate gaze predictions based on features of the gaze instead of the features of the heading, the training system can train the gaze prediction neural network on the gaze prediction task jointly with training the gaze prediction neural network on an auxiliary task of predicting heading directions, e.g., using training samples that may characterize an agent having a gaze direction that is different from a heading direction. The auxiliary tasks are not included in the neural network at inference time on-board the autonomous vehicle.

The technology in this specification is related to generating a gaze prediction that predicts a gaze direction of an agent that is in the vicinity of an autonomous vehicle in an environment, and, in some implementations, using the gaze prediction to generate an awareness signal that indicates whether the agent is aware of the presence of one or more entities in the environment.

The agent can be a pedestrian, a cyclist, a motorcyclist, etc., in the vicinity of an autonomous vehicle in an environment. For example, an agent is in the vicinity of an autonomous vehicle in an environment when the agent is within a range of at least one of the sensors of the autonomous vehicle. That is, at least one of the sensors of the autonomous vehicle can sense or measure the presence of the agent.

The one or more entities in the environment can include the autonomous vehicle, one or more other vehicles, other objects such as the traffic light or road sign in the environment, and so on.

The gaze prediction can be defined as a prediction of the direction of a person’s eyes or face. The agent is aware of the presence of an entity if the agent has knowledge or is informed that an entity exists in the environment. The agent is unaware of the presence of an entity if the agent does not know that an entity exists in the environment.

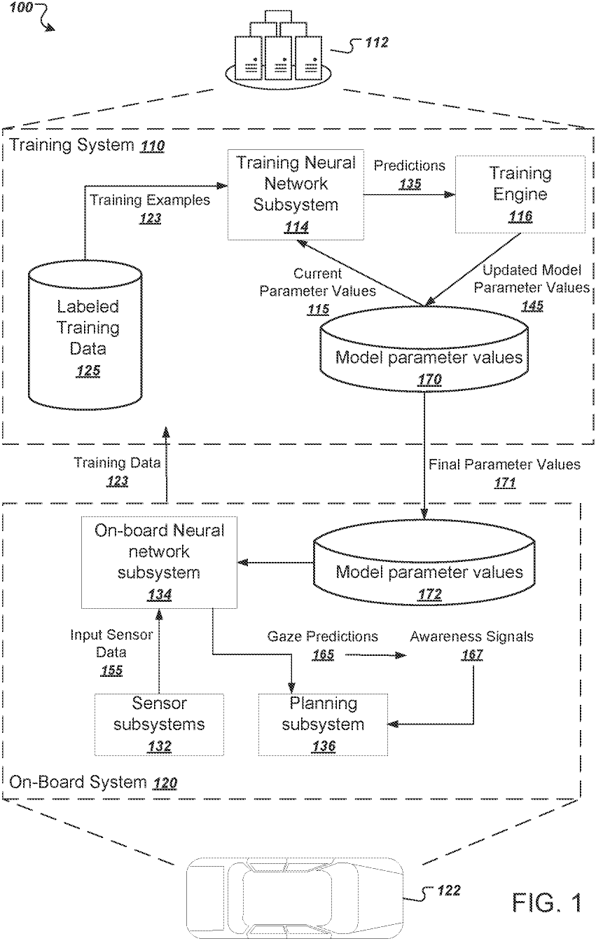

FIG. 1 is a diagram of an example system 100. The system 100 includes a training system 110 and an on-board system 120.

The on-board system 120 is physically located on-board a vehicle 122. Being on-board the vehicle 122 means that the on-board system 120 includes components that travel along with the vehicle 122, e.g., power supplies, computing hardware, and sensors. The vehicle 122 in FIG. 1 is illustrated as an automobile, but the on-board system 120 can be located on-board any appropriate vehicle type.

The on-board system 120 includes one or more sensor subsystems 132. The sensor subsystems include a combination of components that receive reflections of electromagnetic radiation, e.g., lidar systems that detect reflections of laser light, radar systems that detect reflections of radio waves, and camera systems that detect reflections of visible light.

The sensor subsystems 132 provide input sensor data 155 to an on-board neural network subsystem 134. The input sensor data 155 can include data from a plurality of sensor types, e.g., an image patch depicting the agent generated from an image of the environment captured by a camera sensor of the autonomous vehicle, a portion of a point cloud generated by a laser sensor of the autonomous vehicle, and so on.

The input sensor data 155 characterizes an agent in a vicinity of the vehicle 122 in an environment at the current time point. For example, a pedestrian is in the vicinity of an autonomous vehicle in an environment when the pedestrian is within a range of at least one of the sensors of the autonomous vehicle. That is, at least one of the sensors of the autonomous vehicle can sense or measure the presence of the pedestrian.

Generally, the input sensor data 155 could be one or multiple channels of data from one sensor, e.g., just an image, or multiple channels of data from multiple sensors, e.g., an image generated from the camera system and point cloud data generated from the lidar system.

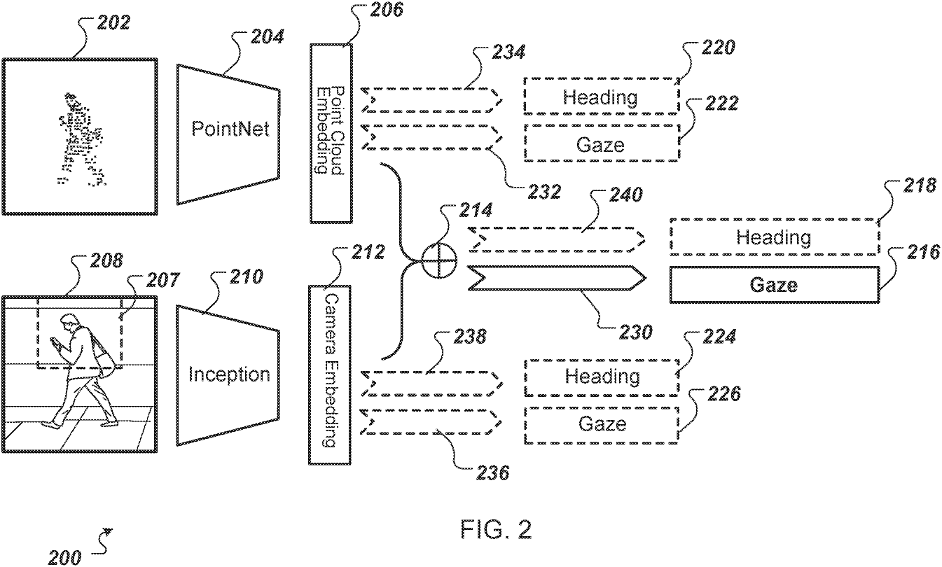

In some implementations, the on-board system 120 can perform pre-processing on the raw sensor data, including projecting the various characteristics of the raw sensor data into a common coordinate system. For example, as shown in FIG. 2, the system can crop, from a camera image 208, an image patch 207 for the upper body (e.g., the torso) of a pedestrian detected in the camera image 208. The system can rotate a raw point cloud to the perspective view to generate a rotated point cloud 202, to match the orientation of the corresponding image patch 207.

The on-board neural network subsystem 134 implements the operations of each layer of a gaze prediction neural network trained to make gaze predictions 165. Thus, the on-board neural network subsystem 134 includes one or more computing devices having software or hardware modules that implement the respective operations of each layer of the neural network according to an architecture of the neural network.

The on-board neural network subsystem 134 can implement the operations of each layer of the neural network by loading a collection of model parameter values 172 that are received from the training system 110. Although illustrated as being logically separated, the model parameter values 170 and the software or hardware modules performing the operations may actually be located on the same computing device or, in the case of an executing software module, stored within the same memory device.

The on-board neural network subsystem 134 can use hardware acceleration or other special-purpose computing devices to implement the operations of one or more layers of the neural network. For example, some operations of some layers may be performed by highly parallelized hardware, e.g., by a graphics processing unit or another kind of specialized computing device. In other words, not all operations of each layer need to be performed by central processing units (CPUs) of the on-board neural network subsystem 134.

The on-board neural network subsystem 134 uses the input sensor data 155 that characterizes an agent in a vicinity of the vehicle 122 in an environment at the current time point to generate a gaze prediction 165. The gaze prediction 165 can predict a gaze of the agent at the current time point.

Each gaze prediction can be defined as a prediction of the direction of a person’s eyes. In some implementations, because detecting the direction of a person’s eyes can be difficult, the gaze prediction can be defined as a prediction of the direction of a person’s face. The gaze prediction can be a direction in a three-dimensional (3D) space, e.g., a 3D vector in the 3D space. In some implementations, the gaze direction can be in 2.5D, i.e., a first gaze direction in the horizontal plane and a second gaze direction in the vertical axis.

For example, the gaze direction in the horizontal plane can be an angle that is between -180 degrees to +180 degrees, and the gaze direction in the vertical axis can be in a plurality of discrete classes, e.g., upward, horizontal, downward, and so on.

Instead of relying on a head detector or a face detector, which may be hard to detect in some cases, the system can accurately predict a gaze direction of an agent directly from raw sensor data or from pre-processed raw sensor data (e.g., an image of an upper body of the detected pedestrian) using the gaze prediction neural network. The gaze prediction neural network can include an embedding subnetwork and a gaze subnetwork. The embedding subnetwork can be configured to directly process sensor data generated by one or more sensors of an autonomous vehicle to generate an embedding characterizing the agent, and the gaze subnetwork can be configured to process the embedding to generate the gaze prediction.

From the gaze prediction 165, the system can generate an awareness signal 167 that indicates whether the agent is aware of the presence of one or more entities in the environment. The one or more entities in the environment can include the vehicle 122, one or more other vehicles, other objects such as the traffic light or road sign in the environment, and so on.

The agent is aware of the presence of an entity if the agent has knowledge or is informed that an entity exists in the environment. The agent is unaware of the presence of an entity if the agent does not know that an entity exists in the environment. For example, a pedestrian is aware of a nearby autonomous vehicle if the pedestrian can see that the autonomous vehicle exists near the pedestrian. As another example, a cyclist is aware of a vehicle behind the cyclist if the cyclist saw the vehicle a moment ago at a crossroad.

In some implementations, the on-board system 120 can predict the probability that the agent is aware of an entity in the environment. In some implementations, the on-board system 120 can predict the probability that the agent does not pay any attention to an entity in the environment, e.g., if the agent is looking at their phone.

In some implementations, the on-board system 120 can generate the awareness signal 167 based on a gaze direction included in the gaze prediction 165. For example, the gaze prediction can be a 3D vector in the 3D space, and if the gaze direction at the current time point is within a predetermined range in 3D near the location of the entity at the current time point, the awareness signal can be determined to indicate that the agent is aware of the entity at the current time point. As another example, the gaze prediction can be in 2.5D, and if the vertical gaze direction of the agent is horizontal and the entity is within a predetermined range centered at the predicted gaze direction in the horizontal plane at the current time point, e.g., within 120 degrees vision span centered at the gaze direction, the system can determine that the agent is aware of the entity in the environment at the current time point.

When a planning subsystem 136 receives the one or more gaze predictions 165 and/or the awareness signals 167, the planning subsystem 136 can use the gaze predictions 165 and/or the awareness signals 167 to make fully-autonomous or semi-autonomous driving decisions. For example, the planning subsystem 136 can use the gaze prediction 165 and/or the awareness signal 167 generated from the gaze prediction 165 to determine a future trajectory of the autonomous vehicle 122.

In some implementations, the gaze prediction 165 can indicate which direction the pedestrian or the cyclist plans to go. For example, if a cyclist is looking to their left, the cyclist probably plans to turn left in the future. Therefore, the planning system 136 can generate a future trajectory of the vehicle 122 to slow down the vehicle 122 and wait until the cyclist has finished making the left turn.

In some implementations, the on-board system 120 can provide the awareness signal to a machine learning model that is used by a planning system of the autonomous vehicle 122 to plan the future trajectory of the autonomous vehicle. In some implementations, the machine learning model can be a behavior prediction model that predicts future behavior of an agent in the environment, e.g., predicting a future trajectory of a pedestrian in the environment based on the awareness signal of the same pedestrian. In some implementations, the machine learning model can be a planning model that plans a future trajectory of the autonomous vehicle based on the awareness signal.

For example, an autonomous vehicle can generate a gaze prediction indicating that a pedestrian at a crosswalk is looking downward at their phone. Based on the gaze prediction, the on-board system of the autonomous vehicle can determine that the pedestrian is not aware of the autonomous vehicle that is approaching the crosswalk. The autonomous vehicle can use a behavior prediction model to generate a future behavior of the pedestrian indicating that the pedestrian is going to cross the roadway in front of the autonomous vehicle because the predicted awareness signal indicates that the pedestrian is not aware of the autonomous vehicle. The autonomous vehicle can use a planning model to generate a future trajectory of the autonomous vehicle that slows down near the pedestrian or yields to the pedestrian.

The on-board neural network subsystem 134 can also use the input sensor data 155 to generate training data 123. The on-board system 120 can provide the training data 123 to the training system 110 in offline batches or in an online fashion, e.g., continually whenever it is generated.

The training system 110 is typically hosted within a data center 112, which can be a distributed computing system having hundreds or thousands of computers in one or more locations.

The training system 110 includes a training neural network subsystem 114 that can implement the operations of each layer of a neural network that is designed to make gaze predictions from input sensor data. The training neural network subsystem 114 includes a plurality of computing devices having software or hardware modules that implement the respective operations of each layer of the neural network according to an architecture of the neural network.

The training neural network generally has the same architecture and parameters as the on-board neural network. However, the training system 110 does not need to use the same hardware to compute the operations of each layer. In other words, the training system 110 can use CPUs only, highly parallelized hardware, or some combination of these.

The training neural network subsystem 114 can compute the operations of each layer of the neural network using current parameter values 115 stored in a collection of model parameter values 170. Although illustrated as being logically separated, the model parameter values 170 and the software or hardware modules performing the operations may actually be located on the same computing device or on the same memory device.

The training neural network subsystem 114 can receive training examples 123 as input. The training examples 123 can include labeled training data 125. Each of the training examples 123 includes input sensor data as well as one or more labels that indicate a gaze direction of an agent represented by the input sensor data.

The training neural network subsystem 114 can generate, for each training example 123, one or more gaze predictions 135. Each gaze prediction 135 predicts a gaze of an agent characterized in the training example 123. A training engine 116 analyzes the gaze predictions 135 and compares the gaze predictions to the labels in the training examples 123. The training engine 116 then generates updated model parameter values 145 by using an appropriate updating technique, e.g., stochastic gradient descent with backpropagation. The training engine 116 can then update the collection of model parameter values 170 using the updated model parameter values 145.

After training is complete, the training system 110 can provide a final set of model parameter values 171 to the on-board system 120 for use in making fully autonomous or semi-autonomous driving decisions. The training system 110 can provide the final set of model parameter values 171 by a wired or wireless connection to the on-board system 120.

FIG. 2 is an example architecture of a gaze prediction neural network 200.

In the example of FIG. 2, the input sensor data includes a point cloud 202 and a camera image 208. The camera image 208 is captured by the camera system of an autonomous vehicle and depicts a pedestrian in a vicinity of the autonomous vehicle in an environment. The pedestrian is looking down at their phone at the current time point. In some implementations, in order to better extract features of the head of the pedestrian, the input sensor data can include an image patch 207 that is cropped from the camera image 208. The image patch 207 can depict a torso portion of the pedestrian, e.g., the upper 50% of the pedestrian detected in the camera image 208. The point cloud 202 is captured by the lidar system of the autonomous vehicle and depicts the same pedestrian in the environment.

The gaze prediction neural network 200 can include an embedding subnetwork that is configured to process the input sensor data generated by one or more sensors of an autonomous vehicle to generate an embedding characterizing the agent. The gaze prediction neural network 200 also includes a gaze subnetwork that is configured to process the embedding to generate the gaze prediction. For example, the embedding subnetwork includes a camera embedding subnetwork 210 that is configured to process the image patch 207 to generate a camera embedding 212 characterizing the pedestrian. As another example, the embedding subnetwork includes a point cloud embedding subnetwork 204 that is configured to process the point cloud 202 to generate a point cloud embedding 204 characterizing the pedestrian. A gaze subnetwork 230 is configured to process the embedding to generate a gaze prediction 216.

Generally, the embedding subnetwork is a convolutional neural network that includes a number of convolutional layers and optionally, a number of deconvolutional layers. Each convolutional layer and deconvolutional layer has parameters whose values define the filters for the layer.

In some implementations, the camera embedding subnetwork can include an InceptionNet 210 as a backbone neural network (Szegedy, Christian, et al. “Inception-v4, inception-resnet and the impact of residual connections on learning.” Thirty-first AAAI conference on artificial intelligence. 2017.) that is configured to generate the camera embedding 212 from an image patch 207 depicting the pedestrian.

In some implementations, the point cloud embedding subnetwork can include a Pointnet 204 as a backbone neural network (Qi, Charles R., et al. “Pointnet: Deep learning on point sets for 3d classification and segmentation.” Proceedings of the IEEE conference on computer vision and pattern recognition. 2017.) that is configured to generate the point cloud embedding 206 from the point cloud 202 depicting the pedestrian.

In some implementations, the embedding subnetwork can be configured to, for each sensor type, process data from the sensor type to generate a respective initial embedding characterizing the agent, and combine, e.g., sum, average, or concatenate, the respective initial embeddings for the multiple sensor types to generate a combined embedding characterizing the agent.

For example, the embedding subnetwork can be configured to generate a first initial embedding, e.g., the camera embedding 212, characterizing the pedestrian from an image patch 207 depicting the pedestrian. The embedding subnetwork can be configured to generate a second initial embedding, e.g., the point cloud embedding 206, characterizing the pedestrian from a portion of a point cloud 202 generated by a laser sensor. The embedding subnetwork can be configured to combine the first initial embedding and the second initial embedding, e.g., by concatenation, addition, or averaging of the two embeddings, to generate a combined embedding 214 characterizing the pedestrian. The gaze subnetwork can be configured to process the combined embedding 214 to generate the gaze prediction 216.

The gaze subnetwork 230 can include a number of convolutional layers, fully connected layers, and regression layers. In some implementations, the gaze subnetwork 230 can include a regression output layer and a classification output layer. The regression output layer can be configured to generate a predicted gaze direction in a horizontal plane, e.g., an angle of 30 degrees in the horizontal plane. The classification output layer can be configured to generate respective scores for each of the classes of the gaze direction in a vertical axis, e.g., upward, horizontal, downward. The system can determine that the predicted gaze direction in the vertical axis is the direction that corresponds to the highest score among the respective scores for each of the classes.

For example, based on the camera image 208 and the point cloud 202, the gaze subnetwork 230 can generate a predicted gaze direction of 10 degrees in the horizontal plane. The gaze subnetwork 230 can generate respective scores for each of the classes of the gaze direction in the vertical axis, e.g., upward: 0.1, horizontal: 0.3, and downward: 0.6. Based on the scores, the system can determine that the predicted gaze direction in the vertical axis is downward.

In some cases, the gaze prediction neural network 200 can be jointly trained with one or more auxiliary tasks. That is, the gaze prediction neural network 200 can be trained with a main task, i.e., the gaze prediction task generated from the gaze prediction head 216, and one or more auxiliary tasks. In particular, each auxiliary task requires a separate subnetwork that generates the prediction for the auxiliary task. For example, the gaze prediction neural network 200 can further include a heading subnetwork 240 that generates the prediction for a heading prediction task.

In some implementations, the one or more auxiliary tasks can include a heading prediction task which requires the system to make a prediction of the direction of the torso of the agent. For example, the gaze prediction neural network 200 can be configured to generate a heading prediction 218 using a heading subnetwork 240. The gaze direction of an agent can be different from the heading direction of the agent. For example, the agent can be walking towards the east direction with the torso direction facing east, while looking to their left with gaze direction towards north. Training the gaze prediction neural network with one or more auxiliary tasks can help improve the accuracy of the gaze prediction by learning the features of the gaze individually, e.g., reducing the chance that the gaze prediction neural network heavily relies on the heading direction of the agent. For example, the system can train the gaze prediction neural network 200 using training samples that may characterize an agent having a gaze direction that is different from a heading direction.

In some implementations, the one or more auxiliary tasks can include one or more auxiliary tasks that measure respective initial gaze predictions made directly from each of the initial embeddings generated from sensor data of respective sensor types. For example, the one or more auxiliary tasks can include an initial gaze prediction 222 generated by a subnetwork 232 that takes the initial embeddings, i.e., the point cloud embedding 206 as input. The one or more auxiliary tasks can optionally include a heading prediction 220 generated by a subnetwork 234 that takes the point cloud embedding 206 as input. As another example, the one or more auxiliary tasks can include an initial gaze prediction 226, and optionally a heading prediction 224, generated by respective subnetworks 236 and 238 from the initial embeddings, i.e., the camera embedding 212 generated from the image patch 207.

During training, a training system, e.g., the training system 110 of FIG. 1, can compare the gaze predictions to the labels in the training examples and compare the predictions of the one or more auxiliary tasks to the labels in the training examples. The training system can generate a main task loss that measures the differences in the main task, i.e., the gaze prediction task, and an auxiliary task loss for each of the one or more auxiliary tasks. The system can generate a total loss by calculating a weighted sum of the main task loss and the one or more auxiliary task losses.

For example, the training system can calculate a main task loss, i.e., a regression loss for the predicted gaze direction in a horizontal plane and a classification loss for the predicted gaze direction in a vertical axis. The training system can calculate an auxiliary task loss for each of the one or more auxiliary tasks, e.g. a loss for the heading prediction 218 predicted from the combined embedding 214, a loss for the gaze prediction 222 predicted from the point cloud embedding 206, a loss for the heading prediction 220 predicted from the point cloud embedding 206, a loss for the gaze prediction 226 predicted from the camera embedding 212, or a loss for the heading prediction 224 prediction from the camera embedding 212. The training system can calculate a total loss that can be a weighted sum of the main task loss and the one or more auxiliary task losses for the one or more auxiliary tasks, e.g., a total loss that is a sum of a main loss for the gaze prediction 216 and an auxiliary task loss for the heading prediction 218.

The training system can then generate updated model parameters based on the total loss by using appropriate updating techniques, e.g., stochastic gradient descent with backpropagation. That is, the gradients of the total loss can be back-propagated through the one or more auxiliary subnetworks into the embedding subnetwork, improving the representations generated by the embedding subnetwork and improving the performance of the neural network 200 on the main task, i.e., the gaze prediction task.

For example, suppose the neural network 200 includes one auxiliary task of a heading prediction that corresponds to the heading output 218. The gradients of the total loss can be back-propagated through the auxiliary subnetwork 240 and the gaze subnetwork 230 into the embedding subnetwork, e.g., the camera embedding subnetwork 212 and/or the point cloud embedding subnetwork 206. The embedding representations generated by the embedding subnetwork can be improved to separately predict a gaze direction and a heading direction. Therefore, the performance of the neural network on the gaze prediction task can be improved, e.g., reducing the chance that the gaze prediction neural network 200 heavily relies on the heading direction of the agent to generate the gaze prediction 216.

As another example, the neural network 200 can include the auxiliary tasks that correspond to the gaze prediction 222 and the heading prediction 220 generated from the point cloud embedding 206. The gradients of the auxiliary task loss can be back-propagated through the auxiliary subnetworks 234 and 232 into the point cloud embedding subnetwork 206. The embedding representations generated by the point cloud embedding subnetwork 206 can be improved to separately predict a gaze direction 222 and a heading direction 220. Therefore, the embedding representations generated by the point cloud embedding subnetwork 206 can be improved to separately predict a gaze direction 222 only based on the point cloud data 202. Therefore, the performance of the neural network on the main task corresponding to the gaze prediction 216 can be improved.

After training is completed, at inference time on-board the vehicle 122, the on-board neural network subsystem 134 can perform the gaze prediction neural network 200 to generate a gaze prediction 216, without performing the one or more auxiliary tasks, e.g., without generating the heading prediction 218.

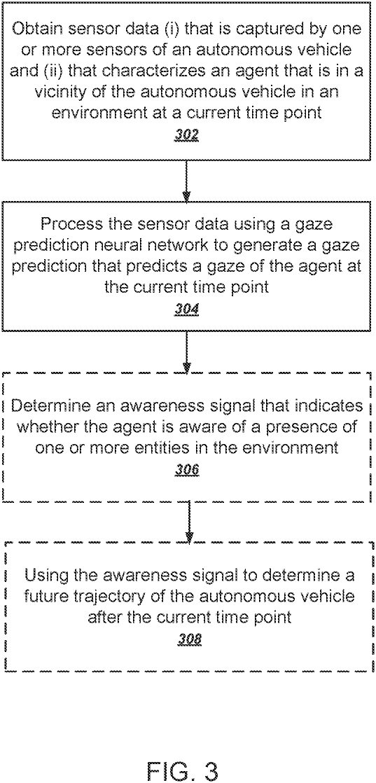

FIG. 3 is a flow chart of an example process for gaze and awareness prediction. The example process in FIG. 3 uses a forward inference pass through a machine learning model that has already been trained to predict a gaze direction of an agent in the environment. The example process can thus be used to make predictions from unlabeled input, e.g., in a production system. The process will be described as being performed by a system of one or more computers in one or more locations, appropriately programmed in accordance with this specification.

For example, the system can be an on-board system located on-board a vehicle, e.g., the on-board system 120 of FIG. 1.

The system obtains sensor data (i) that is captured by one or more sensors of an autonomous vehicle and (ii) that characterizes an agent that is in a vicinity of the autonomous vehicle in an environment at a current time point (302).

The system processes the sensor data using a gaze prediction neural network to generate a gaze prediction that predicts a gaze of the agent at the current time point (304). The gaze prediction neural network includes (i) an embedding subnetwork that is configured to process the sensor data to generate an embedding characterizing the agent, and (ii) a gaze subnetwork that is configured to process the embedding to generate the gaze prediction. The gaze prediction can include a predicted gaze direction in a horizontal plane and a predicted gaze direction in a vertical axis.

In some implementations, the sensor data can include data from a plurality of different sensor types. The embedding subnetwork can be configured to, for each sensor type, process data from the sensor type to generate a respective initial embedding characterizing the agent, and combine the respective initial embeddings to generate a combined embedding characterizing the agent.

In some implementations, the sensor data can include an image patch depicting the agent generated from an image of the environment captured by a camera sensor and a portion of a point cloud generated by a laser sensor.

In some implementations, the gaze prediction neural network can be trained on one or more auxiliary tasks. The one or more auxiliary tasks can include one or more auxiliary tasks that measure respective initial gaze predictions made directly from each of the initial embeddings. In some implementations, the one or more auxiliary tasks can include a heading prediction.

In some implementations, the gaze prediction neural network can include a regression output layer and a classification output layer. The regression output layer can be configured to generate a predicted gaze direction in a horizontal plane and the classification output layer can be configured to generate a predicted gaze direction in a vertical axis.

In some implementations, the system can determine, from the gaze prediction, an awareness signal that indicates whether the agent is aware of the presence of one or more entities in the environment (306). The awareness signal can indicate whether the agent is aware of the presence of the autonomous vehicle. The awareness signal can indicate whether the agent is aware of the presence of one or more other agents in the environment, e.g., one or more other vehicles in the environment, traffic signs, and so on.

In some implementations, the system can generate the awareness signal based on a gaze direction included in the gaze prediction. In some implementations, the awareness signal can be an active awareness signal indicating whether the agent is currently aware of an entity in the environment. The active awareness signal can be generated based on a current gaze direction included in the gaze prediction at the current time point. In some cases, the awareness signal can be determined based on comparing the gaze direction at the current time point with the location of an entity in the environment at the current time point. For example, if the gaze direction at the current time point is within a predetermined range near the location of the entity at the current time point, the awareness signal can be determined to indicate that the agent is aware of the entity at the current time point.

In some cases, the awareness signal can be determined based on a gaze direction in the horizontal plane and a gaze direction in the vertical axis included in the gaze prediction. In some implementations, the system can determine that (i) the predicted gaze direction in the vertical axis is horizontal, and (ii) the entity is within a predetermined range centered at the predicted gaze direction in the horizontal plane. Based on that, the system can determine that the agent is aware of the presence of the entity in the environment.

For example, if the vertical gaze direction of the agent is upward or downward at the current time point, the system can determine that the agent is not aware of an entity in the environment at the current time point. As another example, if the vertical gaze direction of the agent is horizontal and the entity is within a predetermined range centered at the predicted gaze direction in the horizontal plane at the current time point, e.g., within 120 degrees vision span centered at the gaze direction, the system can determine that the agent is aware of the entity in the environment at the current time point.

In some implementations, the awareness signal can include one or more of the active awareness signals and a historical awareness signal. The active awareness signal can indicate whether the agent is aware of the presence of the one or more entities in the environment at the current time point. The historical awareness signal can be determined from one or more gaze predictions at one or more previous time points in a previous time window that precedes the current time point, and can indicate whether the agent is aware of the presence of the one or more entities in the environment during the previous time window.

The historical awareness signal can indicate whether the agent is aware of the presence of the entity in the environment during the previous time window that precedes the current time point. That is, if the agent has been aware of the entity in the past, the agent may remember the presence of the entity. In some implementations, the historical awareness signal can be calculated from a history of the active awareness signal, e.g., one or more active awareness signals for one or more previous time points in the previous time window that precedes the current time point. In some implementations, the historical awareness signal can include one or more of: an earliest time in the time window at which the agent starts to be aware of the entity (according to the active awareness signal at the time), a duration of awareness during a period of time from the current time point (e.g., duration of awareness in the past k seconds), and so on.

For example, the awareness signal can include an active awareness signal indicating that the agent is not aware of the autonomous vehicle at the current time point. The awareness signal can further include a historical awareness signal indicating that the agent was aware of the autonomous vehicle at a previous time point, e.g., 2 seconds ago, when the agent looked at the autonomous vehicle. The system can determine that the agent may remember the presence of the autonomous vehicle because the agent has looked at the autonomous vehicle before. The system can determine that the agent was aware of the autonomous vehicle 2 seconds ago.

In some cases, the awareness signal can be based on other information in addition to the gaze prediction. For example, the awareness signal can be based on gesture recognition outputs or action recognition outputs or agent pose. For example, a gesture recognition output can include a cyclist putting their foot on the ground, and based on this, the awareness signal can be a signal indicating that the cyclist is aware of an autonomous vehicle near the cyclist. As another example, a pedestrian can give a gesture, e.g., a wave, to an autonomous vehicle, indicating that the pedestrian would like the autonomous vehicle to go. In this case, the awareness signal can be a signal based on this gesture, indicating that the pedestrian is aware of the autonomous vehicle near the pedestrian.

In some implementations, the system can use the awareness signal to determine a future trajectory of the autonomous vehicle after the current time point (308). In some implementations, the system can use both the gaze prediction and the awareness signal to determine a future trajectory of the autonomous vehicle after the current time point.

In some implementations, the system can provide an input including the awareness signal to a machine learning model that is used by a planning system of the autonomous vehicle to plan the future trajectory of the autonomous vehicle. In some implementations, the machine learning model can be a behavior prediction model that predicts future behavior of an agent in the environment, e.g., predicting a future trajectory of a pedestrian in the environment based on the awareness signal of the same pedestrian. In some implementations, the machine learning model can be a planning model that plans a future trajectory of the autonomous vehicle based on the awareness signal.

For example, an autonomous vehicle can use a computer system to generate a gaze prediction that predicts the gaze direction of a pedestrian who is going to cross a roadway in front of the autonomous vehicle. The gaze prediction can indicate that the pedestrian is looking downward at their phone. Based on the gaze prediction, the computer system can determine that the pedestrian is not aware of the autonomous vehicle that is approaching the roadway. The autonomous vehicle can use a behavior prediction model to generate a future behavior of the pedestrian indicating that the pedestrian is going to cross the roadway in front of the autonomous vehicle because the predicted awareness signal indicates that the pedestrian is not aware of the autonomous vehicle.

As another example, an autonomous vehicle can use a computer system to generate a gaze prediction that predicts the gaze direction of a cyclist who is traveling in front of the autonomous vehicle. The gaze prediction can indicate that the cyclist is looking towards a direction opposite from the position of the autonomous vehicle. Based on the gaze prediction, the computer system can determine that the cyclist is not aware of the autonomous vehicle that is approaching the cyclist from behind. The autonomous vehicle can use a planning model to generate a future trajectory of the autonomous vehicle that either slows down near the cyclist or maintains enough spatial buffer to the cyclist.

In some implementations, instead of feeding the gaze signal and/or the awareness signal into a machine learning model, the system can use a rule based algorithm to plan the future trajectory of the autonomous vehicle. For example, the autonomous vehicle can autonomously apply the brakes to stop or slow down at the crossroad if the predicted awareness signal indicates that a pedestrian who is going to enter the roadway is not aware of the autonomous vehicle. As another example, the autonomous vehicle can automatically send a semi-autonomous recommendation for a human driver to apply the brakes if the predicted awareness signal indicates that a cyclist is not likely aware of the autonomous vehicle.

In some implementations, the system can, based on the awareness signal, generate a reaction type prediction of an agent, e.g., yield, pass, or ignore the vehicle. For example, if a pedestrian is not aware of the vehicle, the system can predict that the pedestrian is less likely to yield the vehicle. The system can adjust a reaction time using one or more reaction time models based on the awareness signal, e.g., how fast the agent will react to the vehicle’s trajectory. For example, if a cyclist is not aware of the vehicle, the system can determine that the reaction time can be longer, e.g., 0.5 seconds instead of 0.2 seconds, when the cyclist encounters the vehicle at a later time point. The system can adjust the buffer size based on the awareness signal, e.g., increasing the buffer size between the vehicle and the agent when the vehicle passes by the agent, for improved safety. For example, if the agent is not aware of the vehicle, the system can increase the buffer size from 4 meters to 7 meters.

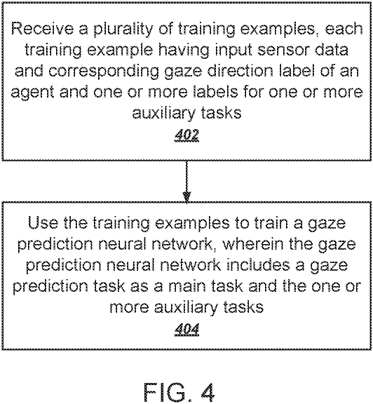

FIG. 4 is a flow chart of an example process for training a gaze prediction neural network with one or more auxiliary tasks. The process will be described as being performed by an appropriately programmed neural network system, e.g., the training system 110 of FIG. 1.

The system receives a plurality of training examples, each training example having input sensor data and corresponding gaze direction label of an agent and one or more labels for one or more auxiliary tasks (402). As discussed above, the input sensor data can include point cloud data. In some cases, the input sensor data can include point cloud data and a camera image. The one or more auxiliary tasks can include a heading prediction task. For example, each training example can include a point cloud that depicts a pedestrian in an environment, and corresponding gaze direction label of the pedestrian and heading direction label of the pedestrian.

The system uses the training examples to train a gaze prediction neural network that includes a gaze prediction task as the main task and the one or more auxiliary tasks (404).

The gaze prediction neural network can include an embedding subnetwork, a gaze subnetwork, and an auxiliary subnetwork for each of the one or more auxiliary tasks. The embedding subnetwork can be configured to process the input sensor data generated by one or more sensors of an autonomous vehicle to generate an embedding characterizing the agent. The gaze subnetwork can be configured to process the embedding to generate the gaze prediction. The auxiliary subnetwork can be configured to process the embedding to generate a prediction for the auxiliary task, e.g., a prediction for a heading direction task.

The system can generate, for each input sensor data in the training examples, a gaze prediction and auxiliary predictions for the one or more auxiliary tasks. For example, the system can generate for each point cloud depicting a pedestrian in an environment, a gaze prediction of the pedestrian and a heading prediction of the pedestrian.

The system can compare the gaze predictions and the auxiliary predictions to the labels in the training examples. The system can calculate a loss which can measure the differences between the predictions and the labels in the training examples. The system can calculate a main loss which measures the differences between the gaze predictions and the gaze direction labels in the training example. For each auxiliary task, the system can calculate an auxiliary task loss which measures the differences between the predictions of the auxiliary task and the labels for the respective auxiliary task. The system can generate a total loss by calculating a weighted sum of the main loss and the one or more auxiliary task losses.

For example, the system can calculate a main loss for the gaze prediction task and an auxiliary loss for the heading prediction task. The system can generate a total loss by calculating a weighted sum of the main loss for the gaze prediction task and the auxiliary task loss for the heading prediction task.

The system can then generate updated model parameter values based on the total loss by using an appropriate updating technique, e.g., stochastic gradient descent with backpropagation. The system can then update the collection of model parameter values using the updated model parameter values. In particular, the gradients of the total loss can be back-propagated through the one or more auxiliary subnetworks into the embedding subnetwork. The embedding representations generated by the embedding subnetwork can be improved to separately predict the gaze direction and predict a prediction for the auxiliary task, e.g., a prediction for the heading direction task. Therefore, the system can improve the representations generated by the embedding subnetwork and improve the performance of the neural network on the main task, i.e., the gaze prediction task.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, which is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, off-the-shelf or custom-made parallel processing subsystems, e.g., a GPU or another kind of special-purpose processing subsystem. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program which may also be referred to or described as a program, software, a software application, an app, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and pointing device, e.g., a mouse, trackball, or a presence sensitive display or other surface by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user’s device in response to requests received from the web browser. Also, a computer can interact with a user by sending text messages or other forms of message to a personal device, e.g., a smartphone, running a messaging application, and receiving responsive messages from the user in return.

In addition to the embodiments described above, the following embodiments are also innovative:

Embodiment 1 is a method comprising:
obtaining sensor data (i) that is captured by one or more sensors of an autonomous vehicle and (ii) that characterizes an agent that is in a vicinity of the autonomous vehicle in an environment at a current time point; and
processing the sensor data using a gaze prediction neural network to generate a gaze prediction that predicts a gaze of the agent at the current time point, wherein the gaze prediction neural network comprises:
an embedding subnetwork that is configured to process the sensor data to generate an embedding characterizing the agent; and
a gaze subnetwork that is configured to process the embedding to generate the gaze prediction.

Embodiment 2 is the method of embodiment 1, further comprising:
determining, from the gaze prediction, an awareness signal that indicates whether the agent is aware of a presence of one or more entities in the environment; and
using the awareness signal to determine a future trajectory of the autonomous vehicle after the current time point.

Embodiment 3 is the method of embodiment 2, wherein the awareness signal indicates whether the agent is aware of a presence of the autonomous vehicle.

Embodiment 4 is the method of any one of embodiments 2-3, wherein the awareness signal indicates whether the agent is aware of a presence of one or more other agents in the environment.

Embodiment 5 is the method of any one of embodiments 2-4, wherein using the awareness signal to determine the future trajectory of the autonomous vehicle after the current time point comprises: providing an input comprising the awareness signal to a machine learning model that is used by a planning system of the autonomous vehicle to plan the future trajectory of the autonomous vehicle.

Embodiment 6 is the method of any one of embodiments 2-5, wherein the gaze prediction comprises a predicted gaze direction in a horizontal plane and a predicted gaze direction in a vertical axis.

Embodiment 7 is the method of embodiment 6, wherein determining, from the gaze prediction, the awareness signal of a presence of an entity in the environment comprises:
determining that the predicted gaze direction in the vertical axis is horizontal;
determining that the entity is within a predetermined range centered at the predicted gaze direction in the horizontal plane; and
in response, determining that the agent is aware of the presence of the entity in the environment.

Embodiment 8 is the method of any one of embodiments 2-7, wherein the awareness signal comprises one or more of an active awareness signal and a historical awareness signal, wherein the active awareness signal indicates whether the agent is aware of the presence of the one or more entities in the environment at the current time point, wherein the historical awareness signal (i) is determined from one or more gaze predictions at one or more previous time points in a previous time window that precedes the current time point and (ii) indicates whether the agent is aware of the presence of the one or more entities in the environment during the previous time window.

Embodiment 9 is the method of any one of embodiments 2-8, further comprising: using both the gaze prediction and the awareness signal to determine a future trajectory of the autonomous vehicle after the current time point.

Embodiment 10 is the method of any one of embodiments 1-9, wherein:
the sensor data comprises data from a plurality of different sensor types, and
the embedding subnetwork is configured to:
   for each sensor type, process data from the sensor type to generate a respective initial embedding characterizing the agent; and
   combine the respective initial embeddings to generate the embedding characterizing the agent.

Embodiment 11 is the method of embodiment 10, wherein the sensor data comprises an image patch depicting the agent generated from an image of the environment captured by a camera sensor and a portion of a point cloud generated by a laser sensor.

Embodiment 12 is the method of any one of embodiments 10-11, wherein the gaze prediction neural network has been trained on one or more auxiliary tasks, wherein the one or more auxiliary tasks include one or more auxiliary tasks that measure respective initial gaze predictions made directly from each of the initial embeddings.

Embodiment 13 is the method of any one of embodiments 1-12, wherein the gaze prediction neural network has been trained on one or more auxiliary tasks.

Embodiment 14 is the method of embodiment 13, wherein the one or more auxiliary tasks include a heading prediction task.

Embodiment 15 is the method of any one of embodiments 1-14, wherein the gaze prediction neural network comprises a regression output layer and a classification output layer, and wherein the regression output layer is configured to generate a predicted gaze direction in a horizontal plane and the classification output layer is configured to generate a predicted gaze direction in a vertical axis.

Embodiment 16 is a system comprising: one or more computers and one or more storage devices storing instructions that are operable, when executed by the one or more computers, to cause the one or more computers to perform the method of any one of embodiments 1 to 15.

Embodiment 17 is a computer storage medium encoded with a computer program, the program comprising instructions that are operable, when executed by data processing apparatus, to cause the data processing apparatus to perform the method of any one of embodiments 1 to 15.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, the method comprising:
obtaining sensor data (i) that is captured by one or more sensors of an autonomous vehicle and (ii) that characterizes an agent that is in a vicinity of the autonomous vehicle in an environment at a current time point; and
processing the sensor data using a gaze prediction neural network to generate a gaze prediction that predicts a gaze of the agent at the current time point, wherein the gaze prediction neural network comprises:
an embedding subnetwork that is configured to process the sensor data to generate an embedding characterizing the agent; and
a gaze subnetwork that is configured to process the embedding to generate the gaze prediction.

2. The method of claim 1, further comprising:
determining, from the gaze prediction, an awareness signal that indicates whether the agent is aware of a presence of one or more entities in the environment; and
using the awareness signal to determine a future trajectory of the autonomous vehicle after the current time point.

3. The method of claim 2, wherein the awareness signal indicates whether the agent is aware of a presence of the autonomous vehicle.

4. The method of claim 2, wherein the awareness signal indicates whether the agent is aware of a presence of one or more other agents in the environment.

5. The method of claim 2, wherein using the awareness signal to determine the future trajectory of the autonomous vehicle after the current time point comprises:
providing an input comprising the awareness signal to a machine learning model that is used by a planning system of the autonomous vehicle to plan the future trajectory of the autonomous vehicle.

6. The method of claim 2, wherein the gaze prediction comprises a predicted gaze direction in a horizontal plane and a predicted gaze direction in a vertical axis.

7. The method of claim 6, wherein determining, from the gaze prediction, the awareness signal of a presence of an entity in the environment comprises:
determining that the predicted gaze direction in the vertical axis is horizontal;
determining that the entity is within a predetermined range centered at the predicted gaze direction in the horizontal plane; and
in response, determining that the agent is aware of the presence of the entity in the environment.

8. The method of claim 2, wherein the awareness signal comprises one or more of an active awareness signal and a historical awareness signal, wherein the active awareness signal indicates whether the agent is aware of the presence of the one or more entities in the environment at the current time point, wherein the historical awareness signal (i) is determined from one or more gaze predictions at one or more previous time points in a previous time window that precedes the current time point and (ii) indicates whether the agent is aware of the presence of the one or more entities in the environment during the previous time window.

9. The method of claim 2, further comprising:
using both the gaze prediction and the awareness signal to determine a future trajectory of the autonomous vehicle after the current time point.

10. The method of claim 1, wherein:
the sensor data comprises data from a plurality of different sensor types, and the embedding subnetwork is configured to:
for each sensor type, process data from the sensor type to generate a respective initial embedding characterizing the agent; and
combine the respective initial embeddings to generate the embedding characterizing the agent.

11. The method of claim 10, wherein the sensor data comprises an image patch depicting the agent generated from an image of the environment captured by a camera sensor and a portion of a point cloud generated by a laser sensor.

12. The method of claim 10, wherein the gaze prediction neural network has been trained on one or more auxiliary tasks, wherein the one or more auxiliary tasks include one or more auxiliary tasks that measure respective initial gaze predictions made directly from each of the initial embeddings.

13. The method of claim 1, wherein the gaze prediction neural network has been trained on one or more auxiliary tasks.

14. The method of claim 13, wherein the one or more auxiliary tasks include a heading prediction task.

15. The method of claim 1, wherein the gaze prediction neural network comprises a regression output layer and a classification output layer, and wherein the regression output layer is configured to generate a predicted gaze direction in a horizontal plane and the classification output layer is configured to generate a predicted gaze direction in a vertical axis.

16. A system comprising one or more computers and one or more storage devices storing instructions that are operable, when executed by the one or more computers, to cause the one or more computers to perform operations comprising:
obtaining sensor data (i) that is captured by one or more sensors of an autonomous vehicle and (ii) that characterizes an agent that is in a vicinity of the autonomous vehicle in an environment at a current time point; and
processing the sensor data using a gaze prediction neural network to generate a gaze prediction that predicts a gaze of the agent at the current time point, wherein the gaze prediction neural network comprises:
an embedding subnetwork that is configured to process the sensor data to generate an embedding characterizing the agent; and a gaze subnetwork that is configured to process the embedding to generate the gaze prediction.

17. The system of claim 16, the operations further comprise:
determining, from the gaze prediction, an awareness signal that indicates whether the agent is aware of a presence of one or more entities in the environment; and
using the awareness signal to determine a future trajectory of the autonomous vehicle after the current time point.

18. The system of claim 17, wherein the awareness signal indicates whether the agent is aware of a presence of the autonomous vehicle.

19. The system of claim 17, wherein the awareness signal indicates whether the agent is aware of a presence of one or more other agents in the environment.

20. One or more non-transitory computer storage media encoded with computer program instructions that when executed by a plurality of computers cause the plurality of computers to perform operations comprising:
obtaining sensor data (i) that is captured by one or more sensors of an autonomous vehicle and (ii) that characterizes an agent that is in a vicinity of the autonomous vehicle in an environment at a current time point; and
processing the sensor data using a gaze prediction neural network to generate a gaze prediction that predicts a gaze of the agent at the current time point, wherein the gaze prediction neural network comprises:
an embedding subnetwork that is configured to process the sensor data to generate an embedding characterizing the agent; and
a gaze subnetwork that is configured to process the embedding to generate the gaze prediction.
